(19) United States
(12) Patent Application Publication
(10) Pub. No.: US 2020/0410486 A1
(43) Pub. Date: Dec. 31, 2020

(54) COMMODITY AND SERVICE EVALUATION SYSTEM AND EVALUATION METHOD

(71) Applicant: SMARTRACT CO., LTD, Tokyo (JP)

(72) Inventor: Yoshiyuki Kubo, Tokyo (JP)

(21) Appl. No.: 16/807,517

(22) Filed: Mar. 3, 2020

(30) Foreign Application Priority Data
Mar. 8, 2019 (JP) 2019-043032

(51) Int. Cl. G06Q 20/38; G06Q 20/36

(52) U.S. Cl. CPC G06Q 20/389; G06Q 20/36

(57) ABSTRACT

The invention provides individual information recording means including: means for recording individual information on the evaluation target in a block chain as a block; evaluation token issuing means for issuing an evaluation token for a commodity/service to be evaluated; and evaluation token storing means for storing the evaluation token issued by the evaluation token issuing means. Accordingly, information recorded and stored by these means can be displayed on a client terminal via each of wallets.

### TECHNICAL FIELD

The present invention relates to a commodity and service evaluation system and a commodity and service evaluation method using a block chain.

### BACKGROUND ART

In recent years, there have been increasing number of fraud acts such as camouflaging the origin and quality of foods or disguising the quality of products and services to be superior to actual ones. These fraud acts may result in damage to brand values of foods, products and services, or such an event that traders or consumers may suffer from disadvantages.

In addition, there have been few objective means for traders or consumers to confirm accurate information on the origin and quality of foods, and actually, information based on indication of the sellers of foods, products, and services is used as means for confirming the information.

In this actual condition, Japanese government has been doing an appropriate origin indication promotion project, a beef traceability business project, and the like as a countermeasure against the fraudulent claiming of origin.

In addition, there has been proposed a system considering the provision of secure and safe foods (PTL 1 and PTL 2).

### CITATION LIST

### Patent Literature

PTL 1: Japanese Patent Laid-Open No. 2010-61282

PTL 2: Japanese Patent Laid-Open No. 2018-88169

### SUMMARY OF INVENTION

### Technical Problem

It is an object of the invention to provide a system and a method to avoid a fraudulent claiming of origin and the quality of foods, and the quality of the products and services, to provide open information allowing traders, sellers, and consumers to come in touch with information such as the origin and quality of foods and quality of products and services, and to use evaluation from the third party as information for evaluation.

### Solution to Problem

In order to achieve the object described above, there is provided a commodity and service evaluation system including: a plurality of client terminals; one or more servers including wallets associated with the plurality of client terminals; and a plurality of servers in which block chains each associated with a predetermined wallet of the wallets are dispersedly recorded, the wallets including a plurality of supplier wallets, a plurality of shop wallets, and a plurality of consumer wallets provided in one or more servers, the supplier wallets and the shop wallets each being associated individually with a separate one of the dispersedly recorded block chains, the shop wallets each including shop evaluation token issuing means configured to access the supplier wallet and issue an evaluation token for an evaluation target, the supplier wallets each including shop evaluation token storing means configured to store the evaluation token issued by the shop evaluation token issuing means, the consumer wallets each including consumer evaluation token issuing means configured to access the shop wallet and issue the evaluation token for the evaluation target, the shop wallets each including consumer evaluation token storing means configured to store the evaluation token issued by the consumer evaluation token issuing means.

The commodity and service evaluation system further includes: supplier individual information recording means configured to record individual information on the evaluation target in a supplier block chain via each of the supplier wallets; and shop individual information recording means configured to record the individual information on the evaluation target in the shop block chains via each of the shop wallets.

In addition, the commodity and service evaluation system includes individual information transcription means configured to transcribe part or entire individual information on the evaluation target from a block of the supplier block chain containing the individual information on the evaluation target when the individual information on the evaluation target is recorded as the block in the shop block chain by the shop individual information recording means.

The commodity and service evaluation system includes: a plurality of producer wallets provided in one or more servers, the producer wallets each being associated individually with a separate one of the dispersedly recorded block chains, the supplier wallets each including supplier evaluation token issuing means configured to access the producer wallet and issue a token for the evaluation target, the producer wallets each including supplier evaluation token storing means configured to store the evaluation token issued by the supplier evaluation token issuing means; and further, individual information transcription means configured to transcribe part or entire individual information on the evaluation target from a block of the producer block chain containing the individual information on the evaluation target when the individual information on the evaluation target is recorded in the supplier block chain by the supplier individual information recording means.

There is also provided a method executed by a commodity and service evaluation system comprising: a plurality of client terminals; one or more servers including wallets associated with the plurality of client terminals; and a plurality of servers in which block chains each associated with a predetermined wallet of the wallets are dispersedly recorded, the wallets including a plurality of producer wallets, a plurality of supplier wallets, a plurality of shop wallets, and a plurality of consumer wallets provided in one or more servers, the producer wallets, the supplier wallets and the shop wallets each being associated individually with a separate one of the dispersedly recorded block chains, the method including: a shop evaluation token issuing step for accessing the supplier wallet and issuing an evaluation token for an evaluation target in each of the shop wallets, a shop evaluation token storage step for storing the evaluation token issued by the shop evaluation token issuing means in each of the supplier wallets, a consumer evaluation token issuing step for accessing the shop wallet and issuing the evaluation token for the evaluation target in each of the consumer wallets, an evaluation token storage step for storing the evaluation token issued by the consumer evaluation token issuing step in each of the shop wallets, a supplier individual information recording step for recording individual information on the evaluation target in a supplier block chain via each of the supplier wallets; a shop individual information recording step for recording the individual information on the evaluation target in the shop block chain via each of the shop wallets; an individual information transcribing step for transcribing part or entire individual information on the evaluation target from a block of the supplier block chain containing the individual information on the evaluation target when the individual information on the evaluation target is recorded as the block in the shop block chain in the shop individual information recording step; a supplier evaluation token issuing step for accessing the producer wallet and issuing a token for the evaluation target by each of the supplier wallets; a supplier evaluation token storage step for storing the evaluation token issued by the supplier evaluation token issuing means by each of the producer wallets; and an individual information transcribing step for transcribing part or entire individual information on the evaluation target from a block of the producer block chain containing the individual information on the evaluation target when the individual information on the evaluation target is recorded in the supplier block chain in the supplier individual information recording step.

The distributed commodity/service evaluation system and evaluation method according to the invention have following advantages.

The information recorded in the block chain is difficult to be tampered with and easily referred to, so that the reliability of information is enhanced and the convenience as information which can be accurately and easily referred to is also enhanced. Further, since the producers, the suppliers, and the shops can also evaluate persons who provide the commodity/service regarding the commodity/service to be evaluated and in addition, the evaluation information can be easily refer to, the quality of the business of the producers, the suppliers, and the shops is improved. In addition, the consumers who can refer to the individual information and the evaluation information on the commodity/service at the shop can purchase and utilize the commodity and service with ease.

### BRIEF DESCRIPTION OF DRAWINGS

FIG. 1 is a diagram illustrating an overall outline of a distributed commodity/service evaluation system using block chains according to the invention;

FIG. 2 illustrates a schematic example of accessing a block chain from a client terminal via a wallet;

FIG. 3 is a flowchart illustrating a flow of creating a producer block chain;

FIG. 4 is a flowchart illustrating a flow of creating a supplier block chain when a commodity/service information to be evaluated is transferred from a producer wallet to a supplier wallet;

FIG. 5 is a flowchart illustrating a flow of creating a supplier block chain when a commodity/service information to be evaluated is not transferred from the producer wallet to the supplier wallet;

FIG. 6 is a flowchart illustrating a flow of creating a shop block chain when a commodity/service information to be evaluated is transferred from the supplier wallet to the shop wallet;

FIG. 7 is a flowchart illustrating a flow performed when an evaluation token is issued from a supplier client terminal to the producer wallet;

FIG. 8 is a flowchart illustrating a flow performed when an evaluation token is issued from a shop client terminal to the supplier wallet; and

FIG. 9 is a flowchart illustrating a flow performed when an evaluation token is issued from a consumer client terminal to the shop wallet.

### DESCRIPTION OF EMBODIMENTS

An object to avoid a fraudulent claiming of origin and quality of foods, and quality of the products and services, to provide open information allowing traders, sellers, and consumers to come in touch with information such as the origin and quality of foods and quality of products and services, and to use evaluation from the third party as information for evaluation is achieved by a distributed commodity/service evaluation system using block chains. As used herein the term “Blockchain” is intended to includes a dispersed network, is a database for storing data by creating data units referred to as “block” and coupling the units like a chain, and is also referred to as “dispersed ledger technology” or “dispersed network”.

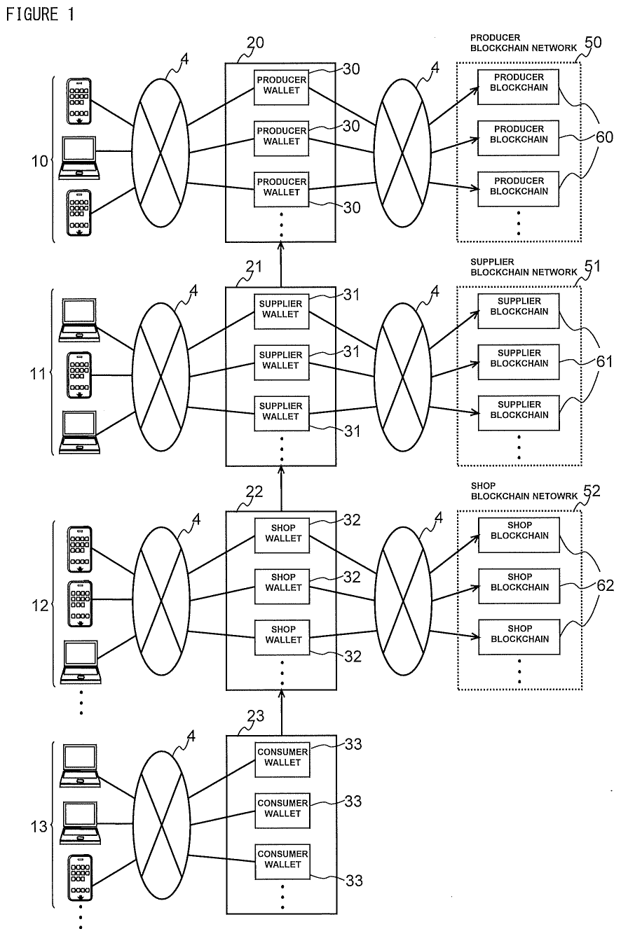

FIG. 1 is a diagram illustrating a general outline of a distributed commodity/service evaluation system according to the invention. The distributed commodity/service evaluation system includes Web DB servers 20, 21, 22, 23 in which a plurality of producer wallets 30, a plurality of supplier wallets 31, a plurality of shop wallets 32, and a plurality of consumer wallets 33 are installed and provided, respectively; block chain networks 50, 51, 52 accessible respectively via networks 4 such as internet from the plurality of producer wallets 30, the plurality of supplier wallets 31, and the plurality of shop wallets 32; and a client terminal capable of accessing the plurality of producer wallets 30, the plurality of supplier wallets 31, the plurality of shop wallets 32, and the plurality of consumer wallets 33 respectively via the networks 4 such as internet.

In the distributed commodity/service evaluation system, the plurality of producer wallets 30 provided in the Web DB server 20 are accessible from the plurality of supplier wallets 31 provided on the Web DB server 21. The plurality of supplier wallets 31 provided on the Web DB server 21 are accessible from the plurality of shop wallets 32 provided on the Web DB server 22. The plurality of shop wallets 32 provided in the Web DB server 22 are accessible from the plurality of consumer wallets 33 provided in the Web DB server 23.

The client terminal includes producer client terminals 10, supplier client terminals 11, shop client terminals 12, and consumer client terminals 13. The producer client terminals 10 are associated with separate producer wallets 30, respectively. The supplier client terminals 11 are associated with separate supplier wallets 31, respectively. The shop client terminals 12 are associated with separate shop wallets 32, respectively. The consumer client terminals 13 are associated with separate consumer wallets 33, respectively.

Producer block chains 60 associated with the separate producer wallets 30 in the producer block chain network 50 respectively are accessible from the producer client terminals 10 via the producer wallets 30. Supplier block chains 61 associated with the individual supplier wallets 31 in the supplier block chain network 51 are accessible from the supplier client terminals 11 via the supplier wallets 31. Shop block chains 62 present in the shop block chain network 52 associated with the shop wallets 32 are accessible from the shop client terminals 12. Each client terminal can access each block chain to read information recorded in blocks of the block chain, or to create a new block.

As used herein the term “block chain network” is intended to include a network including a group of block chain servers configured to dispersedly manage the block chains.

Note that although the Web DB servers 20, 21, 22, 23 are illustrated to be separate in FIG. 1, they may be the same Web DB server.

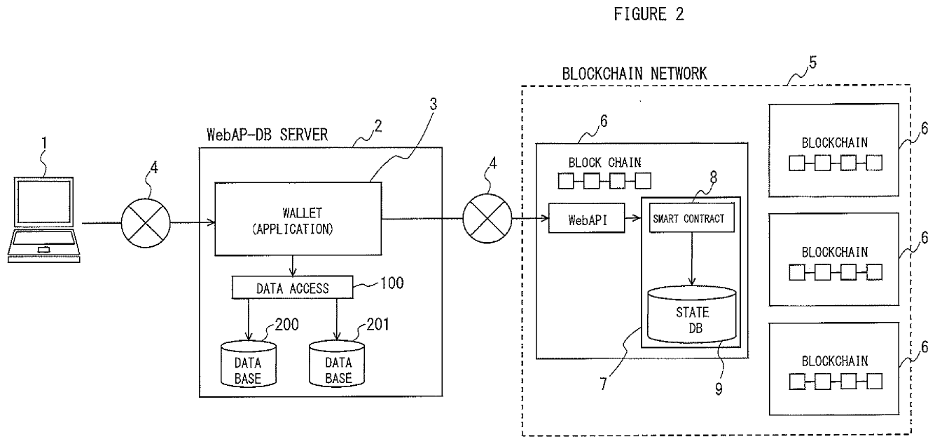

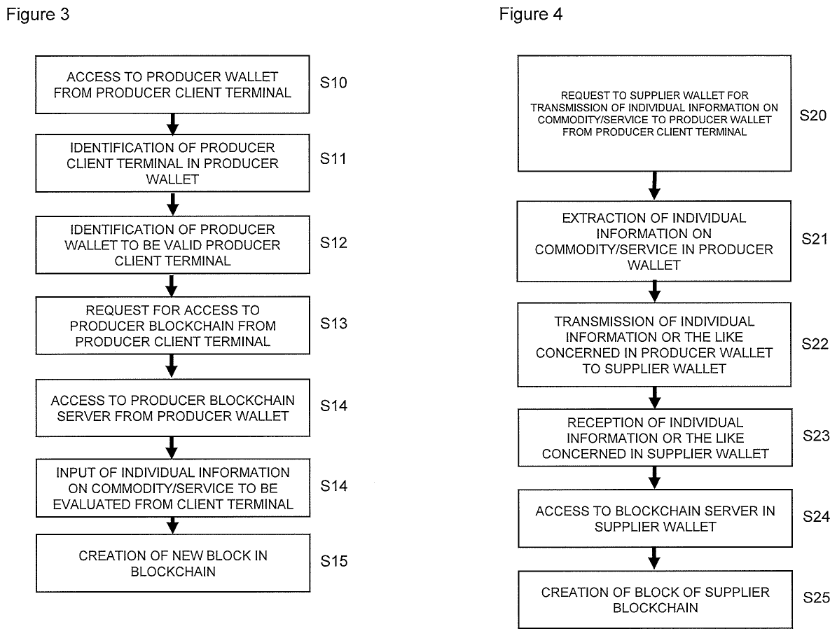

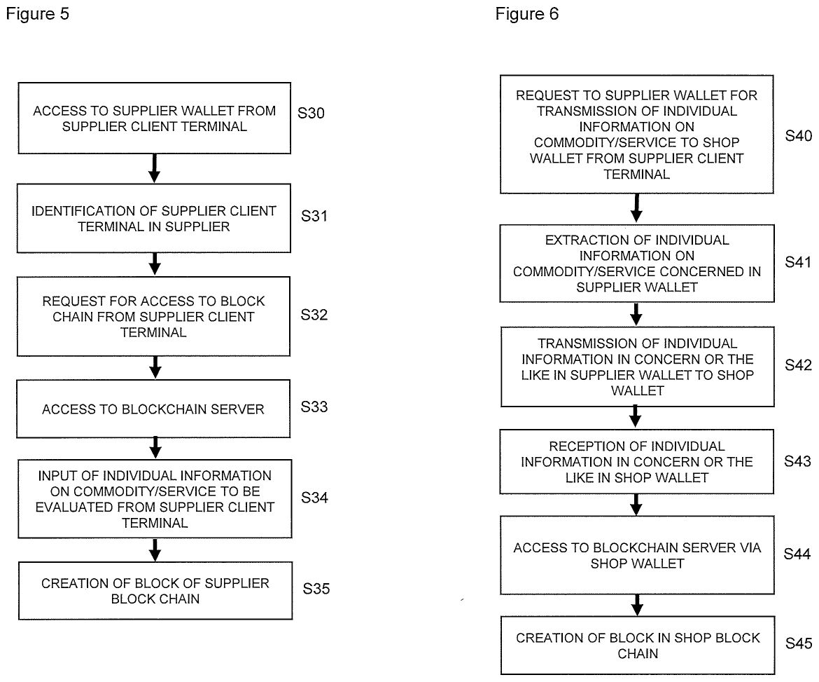

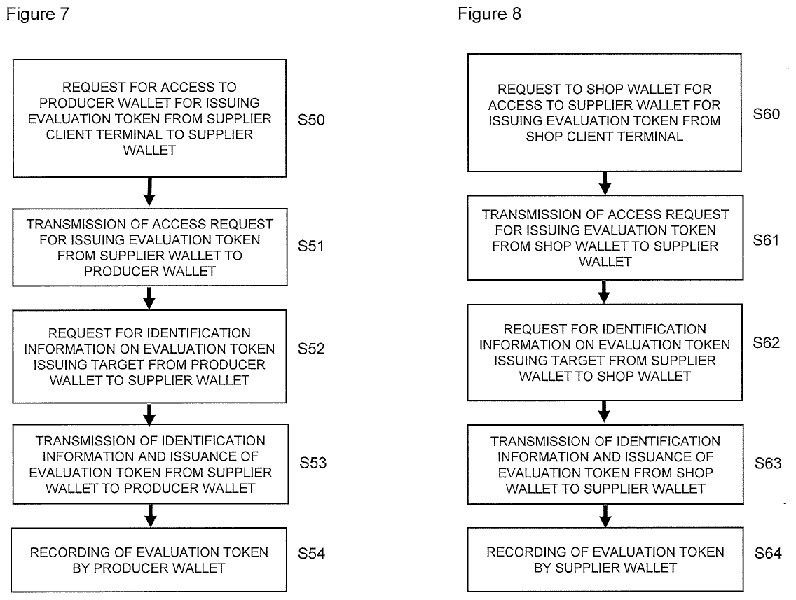

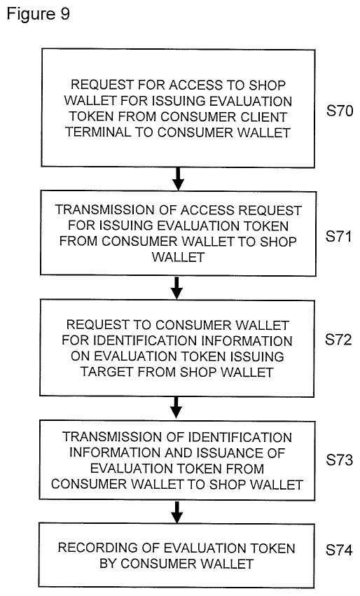

FIG. 2 is a diagram illustrating a general example of accessing a block chain via the Web AP/DB server 2 in which a wallet 3 is installed from a client terminal 1 of each producer, each supplier, or each shop.

This example includes the client terminal 1 which is a terminal such as a tablet type PC, a smartphone, a personal computer, and the like, a Web AP (Web application)/DB server 2, and a block chain network 5. These can communicate with each other via the network 4. The network 4 includes the Internet, a cellular telephone network, a local area, and the like, and is not particularly limited.

The Web AP/DB server 2 is provided with the wallet 3. The wallet 3 is associated with a particular block chain with a predetermined identification number or the like. The wallet 3 is a kind of application, and serves as an interface for accessing the block chain from the client terminal 1.

The wallet 3 accepts an input of the client and performs data access 100 to record data in databases 200, 210 or to access the block chain network 5 via the network 4. The wallet 3 may perform processing such as creation/management of a public key/private key, management of a backup address, and creation of a transaction.

The block chain network 5 is a network of servers for managing the block chains, and includes a block chain servers 6 for managing a plurality of the block chains. The wallet 3 accesses the block chain network 5 via a Web API (Web Application Programming Interface).

The block 7 constituting the block chain includes a smart contract 8, which is a program operated on the block chain, and a state database 9 in which data items to be changed in value is defined by transaction processing as components.

<Flow of Entire System>

A flow of an entire evaluation system for an evaluation target using a bock chain according to the invention will be described.

First, a wallet is allocated in advance to producers, suppliers, shops, and consumers who participate in an evaluation system for evaluating an evaluation target using the block chain according to the invention. The producers, suppliers, shops and consumers can access the block chain network via the allocated wallet and issue an evaluation token as evaluation means. As used herein the term “token” is intended to include elements of minimum units constituting a unit element of a source code, and the term “evaluation token” is the token used for evaluation.

In the following description, flows are described separately for those mediated by the producer wallet 30, the supplier wallet 31, the shop wallet 32, and the consumer wallet 33. In this description, there is also a part which is described as being executed by each wallet, but this is so described for convenience of explanation, and actually, it is executed by the Web DB server 20, 21, 22, and 23 containing the wallets.

1. Flow Mediated by Producer Wallet 30

(1) Creation of Producer Block Chains 60

When a producer wallet 30 provided in the Web AP/DB server 20 is accessed from the producer client terminal 10 via the network 4, the producer wallet 30 identifies the producer client terminal 10 based on identification information such as an identification number from the producer client terminal 10 (S10, S11).

By this identification, when an access request to the block chain is made from the producer client terminal 10 after it is recognized as the valid producer client terminal 10, the producer wallet 30 accesses the block chain server in the producer block chain network 50 for managing the block chain linked to the producer wallet 30 (S12, S13, S14).

Next, when individual information on the commodity/service to be evaluated is entered from the producer client terminal 10, a block of the block chain is created in the block chain server concerned having accepted the information (S14, S15). The creation of the block is performed by a smart contract which is a component of the block.

That is, in the individual producer wallet 30, a new block is created every time the individual information on the commodity/service to be evaluated is entered. The individual information on the commodity/service is recorded in the state database in the block which constitutes the block chain. As used herein the term “individual information on the commodity/service” is intended to include information which is arbitrarily determined of all information which is considered to be necessary for the evaluation of commodity/service.

(2) Transfer of Commodity/Service Information to be Evaluated from Producer Wallet 30 to Supplier Wallet 31

When the producer client terminal 10 requests a producer wallet 30 to transmit the individual information on the commodity/service to a supplier wallet 31, the producer wallet 30 extracts predetermined individual information recorded in the state database of the corresponding block of the producer block chain 60 from identification information such as an identification number or the like of the commodity/service, and transmits the extracted information to the supplier wallet 31 (S20, S21, S22).

As used herein the expression “When the producer client terminal 10 requests the producer wallet 30 to transmit the individual information on the commodity/service to the supplier wallet 31” is intended to means a case where the commodity/service is moved from the producer to the supplier because of being sold or the like.

2. Flow Mediated by Supplier Wallet 31

(1) Creation of Supplier Block Chain 61 when Information is Transmitted from Producer Wallet 30

When a supplier wallet 31 receives the predetermined information on the commodity/service to be evaluated from a producer wallet 30, the supplier wallet 31 accesses the block chain server in the supplier block chain network 51 which manages the supplier block chain 61 associated with the supplier wallet 31 (S23, S24).

Next, in the block chain server, the block of the supplier block chain 61 is created based on the predetermined information on the commodity/service to be evaluated transmitted from the producer wallet 30 (S25). The creation of the block is performed by a smart contract which is a component of the block.

Note that when new information is added to the created block information, a block to which new information is added is created in the information on the created block. For example, when a commodity/service is divided and sold by the supplier, blocks corresponding to the divided commodity/service are created.

When the created block is accessed by the supplier client terminal 11 via the supplier wallet 31 and information such as division is added to the commodity/service information, additional information is newly recorded in the state database by the smart contract.

(2) Creation of Supplier Block Chains 61 from Supplier Client Terminals 11

A case of creating the supplier block chains 61 from the supplier client terminals 11 without transmission of predetermined information about the commodity/service to be evaluated from a producer wallet 30 will be described.

When the supplier client terminal 11 accesses a supplier wallet 31 provided in the Web AP/DB server 21 via the network 4, the supplier wallet 31 identifies the client terminal of the supplier based on identification information such as an identification number from the supplier client terminal 11 (S30 and S31).

When an access request to the supplier block chain 61 is issued from the supplier client terminal 11 after the supplier client terminals is recognized as a valid supplier client terminals 11 by this identification, the supplier wallet 31 accesses a block chain server in the supplier block chain network 51 which manages the block chain associated with the supplier wallet 31 (S32, S33).

Next, when the individual information on the commodity/service to be evaluated is entered from the supplier client terminal 11, the block of the block chain is created in the block chain server having accepted the information (S34, S35). The creation of the block is performed by a smart contract which is a component of the block.

That is, in the individual supplier wallet 31, a new block is created every time the individual information on the commodity/service to be evaluated is entered. The individual information on the commodity/service is recorded in the state database in the block constituting the block chain.

(3) Transfer of Commodity/Service Information to be Evaluated from Supplier Wallet 31 to Shop Wallet 32.

When the supplier client terminal 11 requests a supplier wallet 31 to transmit the individual information on the commodity/service to a shop wallet 32, the supplier wallet 31 extracts predetermined individual information recorded in the state database of the corresponding block of the supplier block chain network 51 from identification information such as an identification number or the like of the commodity/service, and transmits the extracted information to the shop wallet 32 (S40, S41, S42).

As used herein the expression “When the supplier client terminal 11 requests the supplier wallet 31 to transmit the individual information on the commodity/service to the shop wallet 32” is intended to means a case where the commodity/service is moved from the producer to the supplier because of being sold or the like.

(4) When Evaluation Token is Issued to Producer Wallet 30

When a supplier wallet 31 accepts an access request to a producer wallet 30 for issuing the evaluation token from the supplier client terminal 11, the supplier wallet 31 transmits the access request to the producer wallet 30 to the producer wallet 30 concerned (S50, S51).

The producer wallet 30 having accepted the access request requests the supplier wallet 31 to provide information for identifying the block to which an evaluation token is to be issued (S52).

The supplier wallet 31 having accepted the identification information request transmits identification information such as an identification number for identifying individual information on the commodity/service to which an evaluation token is to be issued to the producer wallet 30 and issues an evaluation token (S53).

The producer wallet 30 having accepted the issuance of this token records and stores the evaluation token in association with the block of the producer block chain 60 containing the individual information on the commodity/service which has becomes a target of the issuance of the evaluation token (S54).

(5) Reference of Individual Information on a Commodity/Service

When an individual information request for a specific commodity/service is made from the supplier client terminal 11 to a supplier wallet 31 through the network 4, the supplier wallet 31 performs access processing to a producer wallet 30 via the network 4.

The producer wallet 30 having received an access request from the supplier wallet 31 requests the supplier wallet 31 to transmit the identification information on the supplier wallet 31.

The supplier wallet 31 having accepted the identification information request transmits the identification information to the producer wallet 30.

The producer wallet 30 having accepted the identification information extracts the information concerned of the producer block chain 60 from a predetermined block of the producer block chain 60, and then transmits the extracted information to the supplier wallet 31.

The supplier wallet 31 having accepted the transmitted individual information on the commodity/service also displays the individual information on the commodity/service and also token information linked to the individual information on the commodity/service on the supplier client terminal 11.

The token information is, for example, evaluation information relating to the commodity/service concerned.

3. Flow Mediated by Shop Wallet 32

(1) Creation of Shop Block Chains when Information is Transmitted from Supplier Wallet 31

When a shop wallet 32 receives the predetermined information on a commodity/service to be evaluated from a supplier wallet 31, the shop wallet 32 accesses the block chain server in the shop block chain network 52 that manages the shop block chain 62 associated with the shop wallet 32 (S43, S44).

Next, a block of the shop block chain 62 is created in the block chain server based on predetermined information on the commodity/service to be evaluated transmitted from the supplier wallet 31 (S45). The creation of the block is performed by a smart contract which is a component of the block.

(2) When Evaluation Token is Issued to Supplier Wallet 31

When the shop wallet 32 receives an access request to a supplier wallet 31 for issuing the evaluation token from the shop client terminal 12, the shop wallet 32 transmits the access request to the supplier wallet 31 to the supplier wallet 31 (S60, S61).

The supplier wallet 31 having accepted the access request then requests the shop wallet 32 to provide information for identifying a block to which an evaluation token is to be issued (S62).

The shop wallet having accepted the request for the identification information transmits identification information such as an identification number for identifying individual information on a commodity/service to which an evaluation token is to be issued to the supplier wallet 31 and issues an evaluation token (S63).

The supplier wallet 31 having accepted the issuance of the token associates the evaluation token with a block of a supplier block chain containing the individual information on the commodity/service to which an evaluation token is to be issued, and records and stores the same (S64).

(3) Reference of Individual Information on a Commodity/Service

When a request for individual information on a specific commodity/service is made from a shop client terminal 12 to a shop wallet 32 through the network 4, the shop wallet performs access processing to a supplier wallet 31 via the network 4.

The supplier wallet 31 having received the access request from the shop wallet 32 request the shop wallet 32 to provide identification information on the shop wallets 32.

The shop wallet 32 having received the identification information request transmits the identification information to the supplier wallet 31.

The individual supplier wallet 31 having accepted the identification information extracts information concerned of the supplier block chain 61 from a predetermined block of the supplier block chain 61, and then transmits the extracted information to the shop wallet 32.

The shop wallets 32 having accepted the transmitted individual information on the commodity/service also displays the individual information on the commodity/service and also token information linked to the individual information on the commodity/service on the shop client terminal 12. The token information is, for example, evaluation information relating to the commodity/service concerned.

4. Flow Through Consumer Wallet 33

When the consumer client terminal 13 accesses a consumer wallet 33 provided in the Web AP/DB server 23 via the network 4, the consumer wallet 33 identifies the client terminal of the consumer based on identification information such as the identification number from the consumer client terminal 13.

When the consumer client terminal is recognized as the valid consumer client terminal 13 based on this identification, the consumer wallet 33 is allowed to perform next processing in accordance with an instruction from the consumer client terminals 13.

(1) Reference of Individual Information on Commodity/Service

When a request for individual information on a specific commodity/service is made from the consumer client terminals 13 to a consumer wallet 33 through the network 4, the consumer wallet 33 performs access processing to a shop wallet 32 via the network 4.

The shop wallet 32 having received an access request from the consumer wallet 33 requests the consumer wallet to transmit identification information on the consumer wallet.

The consumer wallet 33 having received the request for the identification information transmits the identification information to the shop wallet 32.

The shop wallet 32 having accepted the identification information extracts information concerned of a shop block chain 62 from a predetermined block of the shop block chain 62, and then transmits the extracted individual information to the consumer wallet.

The consumer wallet 33 having accepted the transmitted individual information on a commodity/service also displays the individual information on the commodity/service and token information linked to the individual information on the commodity/service on the consumer client terminal 13.

The token information is, for example, evaluation information relating to the commodity/service concerned.

(2) Issuing Evaluation Token to Shop Wallet 32

When a consumer wallet 33 has accepted an access request to a shop wallet 32 for issuing an evaluation token from the consumer client terminal 13, the consumer wallet 33 transmits the access request to the shop wallet 32 to the shop wallet 32 concerned (S70, S71).

The shop wallet 32 having accepted the access request requests the consumer wallet 33 to provide information for identifying the block to which an evaluation token is to be issued via the network 4 (S72).

The consumer wallet 33 having accepted the request for the identification information transmits identification information such as an identification number for identifying individual information on a commodity/service to which an evaluation token is to be issued to the shop wallet 32 and issues a token (S73).

The shop wallet 32 having accepted the issuance of the token records and stores the evaluation token in association with a block of a shop block chain 62 containing the individual information on the commodity/service to which the evaluation token is to be issued (S74).

### Examples

As an example of an commodity and service evaluation system according to the invention, a description will be given assuming that between producers and suppliers corresponds to a product type block chain relating to products such as meat and agricultural products and between suppliers to consumers via shops corresponds to a process-type block chain relating to the process of distribution of a commodity/service.

<Product Recording Type Block Chain>

When a producer accesses a producer wallet via a network such as the Internet from a producer client terminal, identification of the producer client terminal is performed, and the producer client terminal is recognized as a valid producer client terminal by this identification.

After this recognition, access to a block chain associated with the producer wallet is enabled and, for example, if it is based on a beef cattle, individual identification information on the beef cattle, for example, implant information/individual identification tag information, DNA information, registration information (sex, place of birth, parent, etc.) are entered, and then a new block is created by the smart contract and these items of information are recorded as a state database.

The producer can access the producer block chain created by individual beef cattle from the producer client terminal via the producer wallet, and create information such as the breeding environment, the feed, the weight and the like of the individual as a new block.

In addition, it is also possible to provide a separate wallet associated with the producer wallet to allow veterinarians or the like to access a block chain containing individual information on a predetermined beef cattle from the separate wallet via the producer wallet and record information such as vaccination of an individual, health status of the individual in a block.

It is also possible to set data of the motion information (information based on a GPS tag or the like) of the individual so that the producer wallet can receive the data to make the block chain of the individual accessible based on the identification information on the individual, and digitize the data of the motion information on the individual and record the data in the block chain. This is recorded by the producer wallet having received the data, such as a GPS tag, by accessing a block chain network and creating a new block in the block chain.

Further, it is also possible to perform condition evaluation processing for evaluating conditions of the individual based on various items of information recorded in the block chain after various items of information on the individual are recorded. The condition evaluation processing may be performed by the Web AP/DB server 2, or may be performed by other servers.

When a predetermined evaluation is made as a result of the condition evaluation processing, an evaluation token based on the evaluation may be issued to be stored in the producer wallet.

Then, the individual is sent as a product to a supplier, such as a slaughtering company for processing a beef cattle, and when the producer wallet receives the shipping information, predetermined information on the individual is transmitted to the supplier wallet of a shipping destination. The transfer processing may be performed by the Web AP/DB server, or may be performed by other servers.

When the supplier wallet receives the predetermined information on the individual distributed as a product from the producer wallet, the supplier wallet accesses the block chain server in the block chain network which manages the supplier block chain linked to the supplier wallet. Then, the block of the supplier block chain is created based on the predetermined information on the individual. The creation of the block is performed by a smart contract which is a component of the block.

When new information is added to the created block information, a block to which new information is added is created in the information on the created block. For example, when beef cattle which is a product is disassembled and divided into individual meat parts at the supplier, corresponding blocks are created. The creation of the block is such that the additional information is newly recorded in the state database by the smart contract, and a new block is created.

<Process Record Type Block Chain>

When a supplier accesses the supplier wallet via a network such as the Internet from a supplier client terminal, identification of the supplier client terminal is performed, and the supplier client terminal is recognized as a valid supplier client terminal.

The slaughtering company of beef cattle accesses a supplier wallet via a network such as the Internet from a supplier client terminal and records information such as whole meat quality, meat quality and meat grade for each part in the block chain. This recording is achieved by the slaughtering company accessing the block chain network from the supplier client terminal via the supplier wallet and creating a new block in the block chain.

The slaughtering company evaluates beef meat quality and records evaluation on the meat quality in a process record type block chain. This recording is achieved by the slaughtering company accessing the block chain network from the client terminal via the individual wallet and creating a new block in the process record type block chain. Then, the record creates a vote (evaluation token) and the vote is stored in the process management wallet concerned.

Recording processing for recording carrier information from a carrier who transport the beef cattle from the producer to the slaughtering company and transport information such as a transportation route, a transportation time, a transportation date and a transportation method in the block chain is performed. This may be achieved by providing a predetermined wallet for the carrier and setting so as to make the supplier wallet accessible via the wallet, so that a new block can be created in a predetermined block chain from the supplier wallet with these items of information as additional information.

Information such as whole meat quality, meat quality and meat grade for each part from the beef slaughtering company is recorded in the process record type block chain. This recording is achieved by the slaughtering company accessing the block chain network from the supplier client terminal via the supplier wallet and creating a new block in the block chain.

The slaughtering company evaluates beef meat quality and records evaluation on the meat quality in a process record type block chain. This recording is achieved by the slaughtering company accessing the block chain network from the supplier client terminal via the supplier wallet and creating a new block in the block chain. Then, the record creates a vote (evaluation token) and the vote is stored in the supplier wallet.

When the slaughtered meat is delivered from the slaughtering company to shops such as butcher shops, supermarkets, department stores, barbecue restaurant and the like, predetermined information relating to the meat concerned recorded in the supplier block chain is transmitted from the supplier wallet to a predetermined shop wallet based on a transmission request from the supplier client terminal.

When the shop wallet receives information about the meat from the supplier wallet, the shop wallet accesses the block chain server in the block chain network that manages the shop block chain associated with the shop wallet.

Then, in the block chain server, the block of the shop block chain is created based on the information about the meat transmitted from the supplier wallet. The creation of the block is performed by a smart contract which is a component of the block.

The consumers who have purchased or eaten the meat at the shop concerned can confirm information about the purchased or eaten meat by accessing from mobile terminal such as their personal computer or a smart phone via a predetermined consumer wallet.

<Evaluation of Cattle and Meat Treated by Producers, Slaughtering Companies, and Shops>

Evaluation of cattle or meat can be made by the slaughtering companies as suppliers for the producer, by the shops for the slaughtering companies, and by the consumers for the shops. The evaluation can be made to a wallet on the side to be evaluated via its own wallet. This vote is processed by a smart contract, which is implemented in block chains in a block chain server, and in the smart contract, the source of voting is clearly disclosed.

Further, the shops are able to make an evaluation on cattle and meat for the slaughtering companies, and the consumers are able to make an evaluation on the same for the shops.

As described above, since the information registered in the block chain is information which is difficult to be tampered with and which can be referred to by anyone, it is possible to obtain reliability as accurate information, and consequently, reliability of the result of evaluation for the object to be evaluated is enhanced. Further, evaluation is performed also for beef producers, carriers, and overseas companies, so that the quality of business of the producer, the carriers, and the slaughtering companies is advantageously improved. Further, the consumers can confirm the history from the production of meat to the sale, and can also know the evaluation result in the distribution process, so that the meat can be eaten with ease.

<Other Applicable Evaluation Target>

In this embodiment, the evaluation system and the evaluation method for evaluation target using the block chain of the invention can also evaluate other meats such as pork, chicken, mutton, horse, and the like, vegetables, fruits, services provided by service providers, web shops, SNS, Twitter (registered trademark), Wikipedia (international registered trademark) and the like.

### REFERENCE SIGNS LIST

1 client terminal
2, 20, 21, 22, 23 Web DB server
3 wallet
4 network
5 block chain network
6 block chain server
7 block
8 smart contract
9 state database
10 producer client terminal
11 supplier client terminal
12 shop client terminal
13 consumer client terminal
30 producer wallet
31 supplier wallet
32 shop wallet
33 consumer wallet
50 producer block chain network
51 supplier block chain network
52 shop block chain network
60 producer block chain
61 supplier block chain
62 shop block chain

What is claimed is:

1. An evaluation system for a commodity and a service, comprising:
a plurality of client terminals;
one or more servers including wallets associated with the plurality of client terminals; and
a plurality of servers in which block chains each associated with a predetermined wallet of the wallets are dispersedly recorded,
the wallets including a plurality of supplier wallets, a plurality of shop wallets, and a plurality of consumer wallets provided in one or more servers,
the supplier wallets and the shop wallets each being associated individually with a separate one of the dispersedly recorded block chains,
the shop wallets each including shop evaluation token issuing means configured to access the supplier wallet and issue an evaluation token for an evaluation target,
the supplier wallets each including shop evaluation token storing means configured to store the evaluation token issued by the shop evaluation token issuing means,
the consumer wallets each including consumer evaluation token issuing means configured to access the shop wallet and issue the evaluation token for the evaluation target,
the shop wallets each including consumer evaluation token storing means configured to store an evaluation token issued by the consumer evaluation token issuing means.

2. The evaluation system for a commodity and a service according to claim 1, further comprising:
supplier individual information recording means configured to record the individual information on the evaluation target in the supplier block chain via each of the supplier wallets; and
shop individual information recording means configured to record the individual information on the evaluation target in a shop block chain via each of the shop wallets.

3. The evaluation system for a commodity and a service according to claim 2, wherein
the commodity and service evaluation system includes individual information transcription means configured to transcribe part or entire individual information on the evaluation target from a block of the supplier block chain containing the individual information on the evaluation target when the individual information on the evaluation target is recorded as the block in the shop block chain by the shop individual information recording means.

4. The evaluation system for a commodity and a service according to claim 1, further comprising a plurality of producer wallets provided on one or more servers,
the producer wallets each being associated individually with a separate one of the dispersedly recorded block chains, wherein
the supplier wallets each include supplier evaluation token issuing means configured to access the producer wallet and issue a token for the evaluation target, and
the producer wallets each include supplier evaluation token storing means configured to store the evaluation token issued by the supplier evaluation token issuing means.

5. The evaluation system for a commodity and a service according to claim 2, further comprising a plurality of producer wallets provided on one or more servers,
the producer wallets each being associated individually with a separate one of the dispersedly recorded block chains, wherein
the supplier wallets each include supplier evaluation token issuing means configured to access the producer wallet and issue a token for the evaluation target, and
the producer wallets each include supplier evaluation token storing means configured to store the evaluation token issued by the supplier evaluation token issuing means.

6. The evaluation system for a commodity and a service according to claim 3, further comprising a plurality of producer wallets provided on one or more servers,
the producer wallets each being associated individually with a separate one of the dispersedly recorded block chains, wherein
the supplier wallets each include supplier evaluation token issuing means configured to access the producer wallet and issue a token for the evaluation target, and
the producer wallets each include supplier evaluation token storing means configured to store the evaluation token issued by the supplier evaluation token issuing means.

7. The evaluation system for a commodity and a service according to claim 2, further comprising:
a plurality of producer wallets provided on one or more servers,
the producer wallets each being associated individually with a separate one of the dispersedly recorded block chains,
the supplier wallets each including supplier evaluation token issuing means configured to access the producer wallet and issue a token for the evaluation target,
the producer wallets each including supplier evaluation token storing means configured to store the evaluation token issued by the supplier evaluation token issuing means; and
individual information transcription means configured to transcribe part or entire individual information on the evaluation target from a block of the producer block chain containing the individual information on the evaluation target when the individual information on the evaluation target is recorded in the supplier block chain by the supplier individual information recording means.

8. The evaluation system for a commodity and a service according to claim 3, further comprising:
a plurality of producer wallets provided on one or more servers,
the producer wallets each being associated individually with a separate one of the dispersedly recorded block chains,
the supplier wallets each including supplier evaluation token issuing means configured to access the producer wallet and issue a token for the evaluation target,
the producer wallets each including supplier evaluation token storing means configured to store the evaluation token issued by the supplier evaluation token issuing means; and
individual information transcription means configured to transcribe part or entire individual information on the evaluation target from a block of the producer block chain containing the individual information on the evaluation target when the individual information on the evaluation target is recorded in the supplier block chain by the supplier individual information recording means.

9. A method executed by a commodity and service evaluation system, comprising:
a plurality of client terminals;
one or more servers including wallets associated with the plurality of client terminals; and
a plurality of servers in which block chains each associated with a predetermined wallet of the wallets are dispersedly recorded,
the wallets including a plurality of producer wallets, a plurality of supplier wallets, a plurality of shop wallets, and a plurality of consumer wallets provided in one or more servers,
the producer wallets, the supplier wallets and the shop wallets each being associated individually with a separate one of the dispersedly recorded block chains, the method including:
a shop evaluation token issuing step for accessing the supplier wallet and issuing an evaluation token for an evaluation target in each of the shop wallets,
a shop evaluation token storage step for storing the evaluation token issued by the shop evaluation token issuing means in each of the supplier wallets,
a consumer evaluation token issuing step for accessing the shop wallet and issuing the evaluation token for the evaluation target in each of the consumer wallets,
an evaluation token storage step for storing the evaluation token issued by the consumer evaluation token issuing step in each of the shop wallets,
a supplier individual information recording step for recording individual information on the evaluation target in a supplier block chain via each of the supplier wallets;
a shop individual information recording step for recording the individual information on the evaluation target in the shop block chain via each of the shop wallets;
an individual information transcribing step for transcribing part or entire individual information on the evaluation target from a block of the supplier block chain containing the individual information on the evaluation target when the individual information on the evaluation target is recorded as the block in the shop block chain in the shop individual information recording step;
a supplier evaluation token issuing step for accessing the producer wallet and issuing a token for the evaluation target by each of the supplier wallets;
a supplier evaluation token storage step for storing the evaluation token issued by the supplier evaluation token issuing means by each of the producer wallets; and
an individual information transcribing step for transcribing part or entire individual information on the evaluation target from a block of the producer block chain containing the individual information on the evaluation target when the individual information on the evaluation target is recorded in the supplier block chain in the supplier individual information recording step.
